(19) United States
(12) Patent Application Publication
(10) Pub. No.: US 2014/0377669 A1
(43) Pub. Date: Dec. 25, 2014

(54) Electrode Structure for Metal-Air Accumulators

(71) Applicant: Robert Bosch GmbH, Stuttgart (DE)

(72) Inventors: Bernd Schumann, Rutesheim (DE); Timm Lohmann, Schwieberdingen (DE)

(21) Appl. No.: 14/359,821

(22) PCT Filed: Sep. 28, 2012
(86) PCT No.: PCT/EP2012/069159

§ 371 Date: May 21, 2014

(30) Foreign Application Priority Data
Nov. 24, 2011 (DE) 10 2011 087 021.0

(51) Int. Cl. H01M 12/08; H01M 4/90

(52) U.S. Cl. CPC H01M 12/08; H01M 4/9016
USPC 429/403

(57) ABSTRACT

A metal-air accumulator includes a nanodimensional tubular or planar structure. A reaction product that is generated during discharge from a reaction with oxygen of air is deposited or precipitated during the reaction in the nanodimensional tubular or planar structure. The nanodimensional tubular or planar structure can be formed from, for example, carbon nanotubes or graphene.

### PRIOR ART

The present invention relates to rechargeable metal-air batteries. These are rechargeable batteries for which (atmospheric) oxygen and metals, typically lithium, magnesium and/or zinc are used as redox elements for generating electric power, with various metal-oxygen compounds such as oxides, peroxides, hyperoxides (which in the following will be referred to as “metal oxides” in the interests of simplicity) being formed.

However, conventional known, for example, rechargeable Li-air batteries frequently suffer from the problem that the metal oxide formed (here: lithium peroxide Li₂O₂) reduces the efficiency of the rechargeable battery because of its relatively poor conductivity.

It is therefore an object of the invention to provide a rechargeable metal-air battery in which this problem can be at least largely avoided.

### DISCLOSURE OF THE INVENTION

This object is achieved by a rechargeable metal-air battery according to claim 1 of the present invention. Accordingly, a rechargeable metal-air battery in which the metal oxide is deposited on a nanodimensional column or sheet structure during discharging is proposed.

It has surprisingly been found that the efficiency of the rechargeable battery can be significantly increased in this way. This is, without being restricted thereto, attributed to the metal oxide being able to deposit between the structural elements of the nanodimensional column or sheet structure.

For the purposes of the present invention, the term “rechargeable metal-air battery” refers, in particular, to a rechargeable battery in which (atmospheric) oxygen and metals, typically lithium, magnesium and/or zinc, are used as redox elements for generating electric power.

As mentioned above, the term “metal oxides” refers to metal-oxygen compounds such as oxides, peroxides, hyperoxides, hydroxides, oxo-hydroxides, etc., which are formed in the reaction between the metal and the oxygen. The term “metal oxide” is used for easier readability and is not intended to mean that only (in the chemical sense) oxides are referred to by this term.

For the purposes of the present invention, the term “nanodimensional column or sheet structure” refers, in particular, to a structure comprising column- or plate-like elements whose average diameter at least in one spatial axis is in the nanodimensional range, i.e. ≦1 μm, preferably in the range ≧10 to ≦800 nm. In the following, “diameter” is this diameter. The precise dimensions often depend on the precise application of the invention.

For the purposes of the present invention, the term “applied” indicates, in particular, that the metal oxide which is formed electrochemically during discharging is bound to the nanodimensional column or sheet structure such that, during operation of the rechargeable battery, said metal oxide is essentially fixed in place and is able to react with (atmospheric) oxygen or another gaseous reactant.

In a preferred embodiment of the invention, the cathode of the rechargeable battery comprises the nanodimensional column or sheet structure, i.e. the nanodimensional column or sheet structure forms the cathode or a part thereof. In this case, the term “applied” means, alternatively or in a supplementary fashion, that, in particular, the nanodimensional column or sheet structure is able to function as cathode of the rechargeable battery even in the case of relatively long-term operation of the rechargeable battery.

In a preferred embodiment of the invention, the nanodimensional column or sheet structure consists essentially of a conductive material which has the conductivity required for use in the cell. Here, the term “essentially” means ≧80% by weight, preferably ≧90% by weight and most preferably ≧95% by weight. This composition has been found useful in practice since these materials are also suitable as cathode materials and the efficiency of the rechargeable battery can be increased in this way.

In a preferred embodiment of the invention, the nanodimensional column or sheet structure consists essentially of a metal which is stable in the cell, electronically conductive oxides or carbon.

In a preferred embodiment of the invention, the distance between two elements of the column or sheet structure is from ≧0.3 times to ≦5 times the smallest average diameter of the elements of the nanodimensional column or sheet structure. The distance between two elements of the column or sheet structure is preferably from ≧0.5 times to ≦2 times, more preferably from ≧0.8 times to ≦1.5 times, the smallest average diameter of the elements of the nanodimensional column or sheet structure. In this way, penetration of the electrodes together with the metal oxide being formed and at the same time the necessary ion-conducting electrolytes which conducts, inter alia and preferably, the metal ions of which the oxide is made up is achieved.

This configuration has been found to be useful in practice since, firstly, the accumulator can be configured most topologically efficiently and, secondly, sufficient space remains for any metal oxide which deposits. In a preferred embodiment of the invention, the distance between two elements of the column or sheet structure is, in absolute dimensions, from ≧20 nm to ≦800 nm, preferably from ≧50 nm to ≦500 nm.

In a preferred embodiment of the invention, the average diameter of the elements of the nanodimensional column or sheet structure is from ≧20 nm to ≦800 nm, preferably from ≧50 nm to ≦500 nm. This has likewise been found to be useful in practice.

In a preferred embodiment of the invention, the nanodimensional column or sheet structure comprises carbon nanotubes or carbon fibers; even more preferably, the nanodimensional column or sheet structure consists essentially of carbon nanotubes or carbon fibers. These materials have been found to be particularly useful in practice because of their superior properties, e.g. as regards processability, porosity, availability.

In a preferred embodiment of the invention, the nanodimensional column or sheet structure is applied to or produced on a support material by a CCVD process. Here, “CCVD” means “Combustion Chemical Vapor Deposition”.

As an alternative or in addition, the nanodimensional column or sheet structure is, in a preferred embodiment of the invention, produced by means of a DRIE process. Here, “DRIE” means “Deep Reactive Ion Etching”.

As an alternative or in addition, the nanodimensional column or sheet structure is, in a preferred embodiment of the invention, obtained by pressing together of fibers or flakes or planar flakes that have been obtained in another way.

These “flakes” can preferably comprise, in particular as a result of a carbonizing reaction, graphenes bound together with a carbon-comprising binder polymer or graphite flake particles with a fiber composite of carbon fibers, or can have these as main constituent. Here, in particular, the binder polymer can bind together precompacted flakes of the abovementioned materials having a fractally configured fiber support structure and as a result of high-temperature treatment form a common conductive carbon flake framework.

Accordingly, in a preferred embodiment of the invention, the nanodimensional column or sheet structure comprises a fractally built up composite of fibers having diameters in the micron and nanometer range in which precompacted flake structures which are chemically or physically bound to one another by means of a thermal process, in the case of carbon a thermal carbonization process, are incorporated.

The fibers preferably have, firstly, a proportion of μm-sized support material which consists, for example, of 0.3-5 μm of fibers and, secondly, an incorporated proportion of nanofibers (carbon nanotubes), referred to here as “fine fraction” which is located in between and, in particular, contacts the coarse support fiber material in a conductive manner and considerably increases the electrode surface area. This latter nanofiber fraction is preferably configured so that the distance between the fine fibers is approximately from 0.3 to 1.5 times the fiber diameter of the fine fibers, with the maximum of the distribution being about 1 time the fiber diameter as distance between the fibers of the fine fraction.

The abovementioned components to be used according to the invention and also those claimed and described in the examples are not subject to any particular exceptions in terms of their size, shape, selection of material and technical conception, so that the selection criteria known in the field of use can be employed without restriction.

Further details, features and advantages of the subject matter of the invention can be derived from the dependent claims and from the following description of the associated drawings in which, by way of example, a number of examples of the rechargeable battery of the invention are depicted. In the drawings:

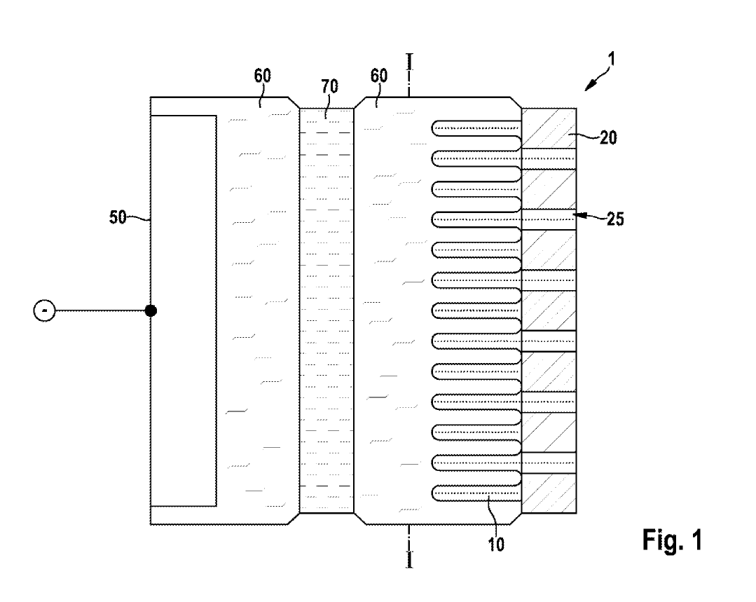

FIG. 1 shows a very schematic cross-sectional side view of a rechargeable battery according to a first embodiment of the invention.

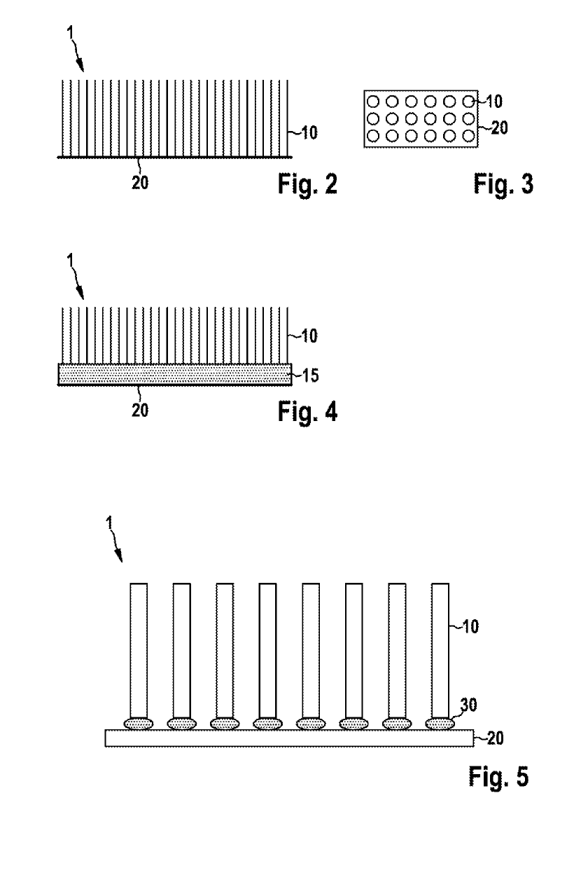

FIG. 2 shows a schematic side view of a section of the rechargeable battery of FIG. 1

FIG. 3 shows a very schematic plan view of the cathode of the rechargeable battery according to the embodiment of FIG. 1 approximately at the level of the line I-I in FIG. 1

FIG. 4 shows a schematic side view of a section of the cathode of FIG. 3 after having been operated

FIG. 5 shows a very schematic side view of a section of a cathode of a rechargeable battery according to a second embodiment of the invention

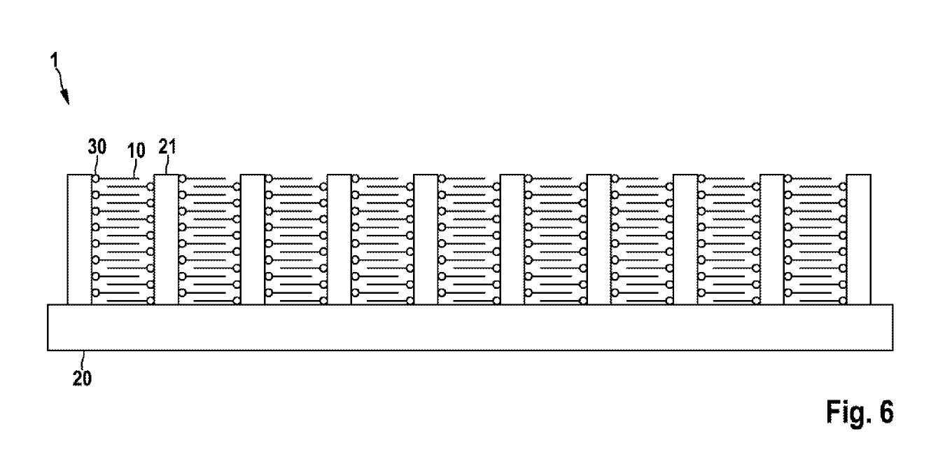

FIG. 6 shows a very schematic side view of a section of a cathode of a rechargeable battery according to a third embodiment of the invention

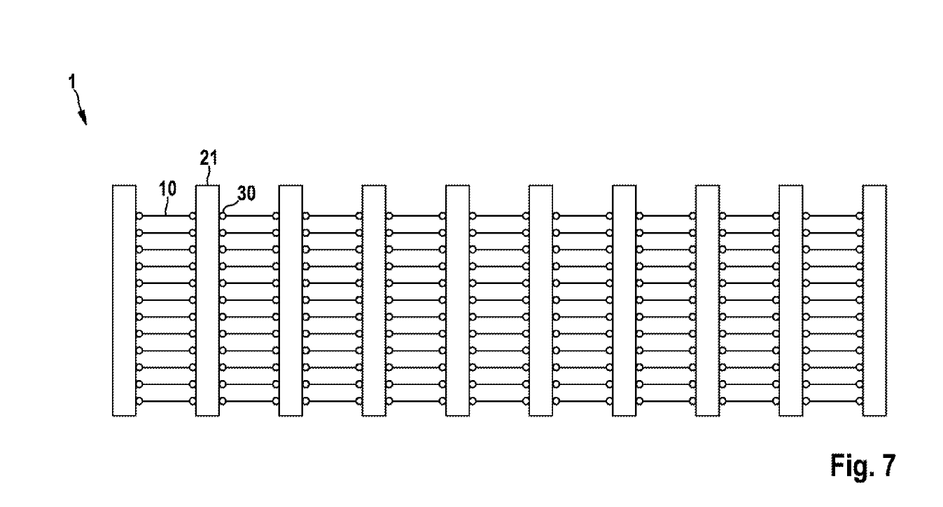

FIG. 7 shows a very schematic side view of a section of a cathode of a rechargeable battery according to a fourth embodiment of the invention

FIG. 1 shows a very schematic cross-sectional side view of a rechargeable battery according to a first embodiment of the invention, in which an essentially column-like configuration of the nanodimensional column or sheet structure 10 was selected. The structure 10 has been applied to an electrode support 20 and, in this specific embodiment, consists of carbon nanotubes in which lithium oxide is embedded. FIG. 2 shows the structure in a very schematic sectional view, while FIG. 3 shows a plan view, approximately along the line I-I in FIG. 1. The rechargeable battery 1 in this embodiment of the invention comprises a metal sheet 50 (for instance lithium) as anode which is adjoined by a first section 40 which is filled with an electrolyte solution and is separated from a second section 60 by a separator 70. In this second section 60, the electrolyte solution comes into contact with the nanodimensional column or sheet structure 10 which has in turn been applied to the electrode support 20. The electrode support 20 has pores 25 for access of air at suitable places, so that the redox reaction can take place.

It can readily be seen from FIG. 3 that the average distance between two columns corresponds essentially to the diameter of the columns, which represents a preferred embodiment of the invention.

FIG. 4 shows a schematic side view of a section of the rechargeable battery 1 analogous to FIG. 2 according to the first embodiment of the invention after having been operated. It can be seen that the Li₂O₂ formed (denoted as 15 in the drawing) is incorporated essentially between the columns 10, i.e. the electron flow by the fibers is ensured throughout. The resultant reaction front, i.e. the zone in which the lithium ion reacts with atmospheric oxygen according to the equation:

2 Li⁺+O₂+2 e^{-->Li}₂O₂,

is, in the case of most rechargeable batteries studied, essentially directly above the Li₂O₂ layer being formed.

FIG. 5 shows a very schematic side view of a section of a cathode of a rechargeable battery 1 according to a second embodiment of the invention, with identical reference numerals denoting identical elements which in the following are explained only insofar as they differ from the embodiment in FIG. 1. This embodiment corresponds essentially to the embodiment in FIG. 1, except that the carbon nanotubes 10 have been applied to the electrode support 20 by means of the CCVD technology and a catalyst or initiator 30 was used for this purpose. This catalyst or initiator 30 can, for example, consist of nickel or other materials known from the prior art. The tube lengths which can thus be achieved are in the micron range and can be up to several 100 μm long.

As an alternative to the direct deposition of the catalyst particles by the CCVD technology, it is also possible to carry out a prestructuring of the electrode support 20 first. In this case, the electrode support consists of a conductive inorganic or organic material which has, for example, been pyrolized to carbon. For example, a semiconducting material such as highly doped silicon can also be used, provided that this firstly has a sufficient electronic conductivity and secondly can be worked using structuring processes from semi-conductor technology.

FIG. 6 shows a very schematic side view of a section of a cathode of a rechargeable battery 1 according to a third embodiment of the invention, with identical reference numerals referring to identical elements which will in the following be explained only when they differ from the embodiment in FIG. 1. In this embodiment, the nanodimensional column or sheet structure 10 has been deposited on the inside of lamellae which were structured from a highly doped silicon wafer by means of the “Deep Reactive Ion Etching” (DRIE) technology. Here, the electrode support structure is more complex in that further supports 21 from which the nanodimensional column or sheet structure 10 extends have in turn been built up on the electrode support 20. This allows a more dense mode of construction of the rechargeable battery.

FIG. 7 shows a side view according to a fourth embodiment of the invention, with identical reference numerals denoting identical elements which will in the following be explained only insofar as they differ from the embodiment according to FIG. 1. This embodiment differs from that of FIG. 6 in that the nanodimensional column or sheet structure 10 is made up of “rods” running continuously between the two supports.

The individual combinations of the constituents and the features of the embodiments mentioned above are illustrative; exchange and substitution of these teachings with/by other teachings present in this document with the cited documents are likewise expressly encompassed. A person skilled in the art will realize that variations, modifications and other embodiments described here can likewise occur without going away from the inventive concept and the scope of the invention. Correspondingly, the above description is illustrative and should not be regarded as restrictive. The word “comprise” used in the claims does not rule out other constituents or steps. The indefinite article “a” does not exclude the meaning of a plural. The simple fact that particular dimensions are recited in mutually different claims does not indicate that a combination of these dimensions cannot be used advantageously. The scope of the invention is defined in the following claims and the associated equivalents.

1. A rechargeable metal-air battery comprising a nanodimensional column or sheet structure, wherein a metal oxide is deposited on the nanodimensional column or sheet structure during discharging.

2. The rechargeable metal-air battery as claimed in claim 1, wherein a cathode of the rechargeable battery comprises the nanodimensional column or sheet structure.

3. The rechargeable metal-air battery as claimed in claim 1, wherein the nanodimensional column or sheet structure consists essentially of metal, electronically conductive oxides, carbon, or compounds thereof.

4. The rechargeable metal-air battery as claimed in claim 3, wherein a distance between two elements of the nanodimensional column or sheet structure (10) is from ≧0.3 times to ≦5 times a smallest average diameter of the elements of the nanodimensional column or sheet structure.

5. The rechargeable metal-air battery as claimed in claim 1, wherein a distance between two elements of the nanodimensional column or sheet structure is from ≧0.3 times to ≦5 times the a smallest average diameter of the elements of the nanodimensional column or sheet structure.

6. The rechargeable metal-air battery as claimed in claim 1, wherein a distance between two elements of the nanodimensional column or sheet structure is from ≧20 nm to ≦800 nm.

7. The rechargeable metal-air battery as claimed in claim 1, wherein an average diameter of elements of the nanodimensional column or sheet structure is from ≧20 nm to ≦800 nm.

8. The rechargeable metal-air battery as claimed in claim 1, wherein the nanodimensional column or sheet structure disposed on a support material by a combust chemical vapor deposition process.

9. The rechargeable metal-air battery as claimed in claim 1, wherein the nanodimensional column or sheet structure comprises a fractally built up composite of fibers having diameters in the micron and nanometer range, in which precompacted flake structures, which are chemically or physically bound to each other via a thermal process are incorporated.

10. The rechargeable metal-air battery as claimed in claim 1, wherein the nanodimensional column or sheet structure is produced via a deep reactive ion etching process.
